(19) United States
(12) Patent Application Publication
(10) Pub. No.: US 2016/0122234 A1
(43) Pub. Date: May 5, 2016

(54) METHOD FOR TREATING SURFACE OF RELEASING CHAMBER IN CONTACT WITH TEST OBJECT

(71) Applicant: Keyu XIA, GUANGDONG (CN)

(72) Inventor: Keyu XIA, GUANGDONG (CN)

(73) Assignee: DONGGUAN CITY SIMPLEWELL TECHNOLOGY CO.,LTD, GUANGDONG (CN)

(21) Appl. No.: 14/374,916

(22) PCT Filed: Jul. 20, 2012
(86) PCT No.: PCT/CN2012/078931

§ 371 Date: Oct. 7, 2014

(30) Foreign Application Priority Data
Feb. 29, 2012 (CN) 201210049393.6

(51) Int. Cl. C03C 17/22; C23C 26/00; C03C 17/25; C03C 17/30; C03C 17/32; C23C 28/00; C03C 17/34

(52) U.S. Cl. CPC C03C 17/22; C23C 28/00; C23C 26/00; C03C 17/3417; C03C 17/30; C03C 17/3441; C03C 17/34; C03C 17/32; C03C 17/25; C03C 2217/20; C03C 2217/213; C03C 2217/70; C03C 2218/111; C03C 2218/113; C03C 2218/31; C03C 2218/32

(57) ABSTRACT

A method for treating surface of releasing chamber in contact with test object comprising the following steps: (1) with regard to components made by processing stainless steel or glass, if the component is stainless steel, the stainless steel component is oxidized with an acid and then washed with an organic solvent and water, or electrolyzed after oxidation and then washed with an organic solvent and water; if the component is glass, the glass component is corroded by HCL or HF, or the surface thereof is roughened by a physical method; and (2) then follows production of a deactivated layer by processing the surface of the component washed in step (1), or first production of an intermediate layer by processing the surface of the component washed in step (1), and then production of a deactivated layer by processing the surface of the intermediate layer.

### BACKGROUND OF THE INVENTION

The present invention relates to a method for treating the surface of a test device for test of volatile organic compounds (VOC), semi-volatile organic compounds (SVOC) and high-boiling-point organic compounds in contact with a test object.

A traditional test device for test of volatile organic compounds (VOC), semi-volatile organic compounds (SVOC) and high-boiling-point organic compounds, such as a releasing chamber (also called a sampler), is composed of the following components: a chamber; a chamber door, a suction tube, an exhaust tube and a sampling tube connected with the chamber; a stirring fan mounted in the chamber; an air duct board (8); and other components; the inner wall of the chamber and the surface in contact with the test object of each component have some chemical bonds adsorbing the test object or strong surface tension, which results in the adsorption of the test object on the inner wall of the chamber and on the surface in contact with the test object of each component and hard removal therefrom. For polar compounds, the adsorption capacity is stronger due to the influence of some chemical bonds on the inner wall of the chamber and on the surface in contact with the test object of each component. Therefore, the inner wall of the chamber and the surface in contact with the test object of each component have to be treated, so as to make the chemical bonds on the inner wall of the test device such as a hydrogen bond, a silanol group and a Lewis acid activation point covered, which results in easy adsorption of the test object on the inner wall of the chamber and on the surface in contact with the test object of each component; when sampling for analysis of the content of the test object, a sample obtained from a sampling tube of the test device is used for the test; since the inner wall of the chamber and the surface in contact with the test object of each component adsorb a great amount of the test object, the tested value of the samples is less than the actual value of the test object in the chamber, having a great testing error, not effectively meeting the needs of a high-precision test.

### BRIEF SUMMARY OF THE INVENTION

The purpose of the present invention is to overcome the above defects of the prior art, and provide a method for treating the surface of a releasing chamber in contact with a test object, which can greatly reduce the adsorption of a test object on the inner wall of the chamber and on the surface in contact with the test object of each component, thus effectively improving the testing precision of the releasing chamber.

In order to achieve the above purpose, the present invention provides the following technical solution: A method is provided for treating the surface of a releasing chamber in contact with a test object, the releasing chamber comprising the following components: a chamber; a chamber door, a suction tube, an exhaust tube and a sampling tube connected with the chamber; a stirring fan mounted in the chamber; and an air duct board; the method is used for treating the surface of at least one component of the chamber, the chamber door, the suction tube, the exhaust tube, the sampling tube, the stirring fan and the air duct board in contact with the test object, comprising the following steps:

(1) with regard to the components made by processing stainless steel or glass, first washing each of the components to remove contaminants; if the component is stainless steel, the stainless steel component is oxidized with an acid and then washed with an organic solvent and water, or electrolyzed after oxidation and then washed with an organic solvent and water; if the component is glass, the glass component is corroded by HCL or HF, or the surface thereof is roughened by a physical method; other methods can also be used to wash each of the components to remove contaminants; and

(2) then follows production of a deactivated layer by processing the surface of the component washed in step (1), or first production of an intermediate layer by processing the surface of the component washed in step (1), and then production of a deactivated layer by processing the surface of the intermediate layer.

If the component is stainless steel, the SiO2 layer of said intermediate layer is obtained by calcining the component washed in step (1) at a temperature above 500° C. with the introduction of monosilane, or by calcining the component washed in step (1) at a temperature above 500° C. after coating, dip-coating or plating it with silicone, or by calcining the component washed in step (1) at a temperature above 500° C. after coating, dip-coating or plating it with polysiloxanes and cyclodextrin derivatives, said polysiloxanes including a polydimethylsiloxane, a phenyl-containing polysiloxane, a cyanogen-containing polysiloxane, a fluorine-containing polysiloxane, a vinyl-containing polysiloxane, a hydrocarbyl-ended polysiloxane, or a polysiloxane with a space group introduced between a molecular chain and a functional group; said intermediate layer or epoxy compound and amine compound containing in a pore-forming agent no carbon atom or heterocycle derived from aromatic compounds undergo a polymerization reaction at 60-200° C. to form a gelatinous substance; then coating or dipping the component washed in step (1), washing away the pore-forming agent with a solvent, and drying after leaving a skeleton phase to form a three-dimensional mesh or porous skeleton phase, said pore-forming agent including methyl cellosolve, ethyl cellosolve, methyl glycol acetate, propylene glycol monomethyl ether acetate and other esters, and polyglycol or polypropylene glycol, said epoxy compound including 2,2,2-tri-(2,3-epoxypropyl)isocyanurate, said amine compound including ethanediamine, diethylene triamine, trithylenetetramine, tetraethylenepentamine, iminobispropylamine/dihexylenetriamine, 1,3,6-triaminomethylhexane, polymethylene diamine, trimethyl hexamethylene diamine, polyether diamine, isophorone diamine, menthane diamine, N-aminoethylpiperazine, 3,9-bis(3-aminopropyl)-2,4,8,10-tetraoxaspiro ring, bis(4-aminocyclohexyl)methane, or aliphatic polyamides made from polyamines and dimer acid; if the component is glass, the intermediate layer is produced by depositing silica, sodium chloride or carbon black onto the surface of the component.

Said deactivated layer is obtained by coating, dip-coating or plating the intermediate layer or the surface of the component with a low-surface-tension organic compound and then baking it at a high temperature above 300° C.; or said deactivated layer is obtained by coating, dip-coating or plating the surface of the component washed in step (1) or the intermediate layer with SiO2 sol and then baking it at a high temperature above 300° C. and finally removing excess materials with a solvent; or said deactivated layer is obtained by coating, dip-coating or plating the surface of the component washed in step (1) or the intermediate layer with polybenzimidazole pyrrolidone (PY), polytetrafluoroethylene, polyfluoroalkyls, orthosilicate or ethyl orthosilicate and then baking it at a high temperature above 300° C.

The method of the present invention for treating the surface of a releasing chamber in contact with a test object has the following beneficial effects: The method is used for production of a deactivated layer by processing the surface of the component washed in step (1), or first production of an intermediate layer by processing the surface of the component washed in step (1), and then production of a deactivated layer by processing the surface of the intermediate layer. This reduces the surface tension of the inner wall of the chamber and the surface in contact with the test object of each component, which can greatly reduce the adsorption of a test object on the inner wall of the chamber and on the surface in contact with the test object of each component, so that the tested value of the samples taken from a sampling tube is closer to the actual value of the test object in the chamber, thus effectively improving the testing precision of the releasing chamber.

The method of the present invention for treating the surface of a releasing chamber in contact with a test object will be further described below with reference to drawings and examples.

### BRIEF DESCRIPTION OF THE DRAWINGS

FIG. 1 is a structural schematic drawing of the intermediate layer and deactivated layer applied to the releasing chamber as described in the method of the present invention for treating the surface of the releasing chamber in contact with a test object;

FIG. 2 is an enlarged sectional view along the line A-A in FIG. 1;

FIG. 3 is an enlarged sectional view along the line B-B in FIG. 1;

FIG. 4 is a structural schematic drawing of the coating layer applied to the releasing chamber as described in the method of the present invention for treating the surface of the releasing chamber in contact with a test object;

FIG. 5 is an enlarged sectional view along the line C-C in FIG. 4;

FIG. 6 is an enlarged sectional view along the line D-D in FIG. 4.

### DETAILED DESCRIPTION OF THE INVENTION

The most preferred examples of the method of the present invention for treating the surface of a releasing chamber in contact with a test object are described as follows, but not thereby limit the scope of protection of the present invention.

### Example 1

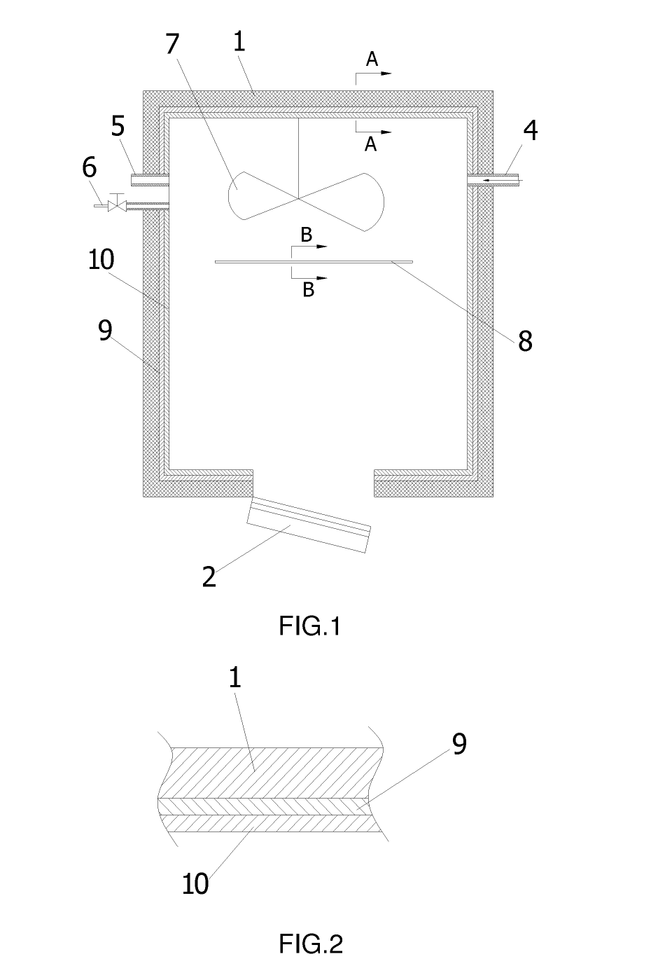

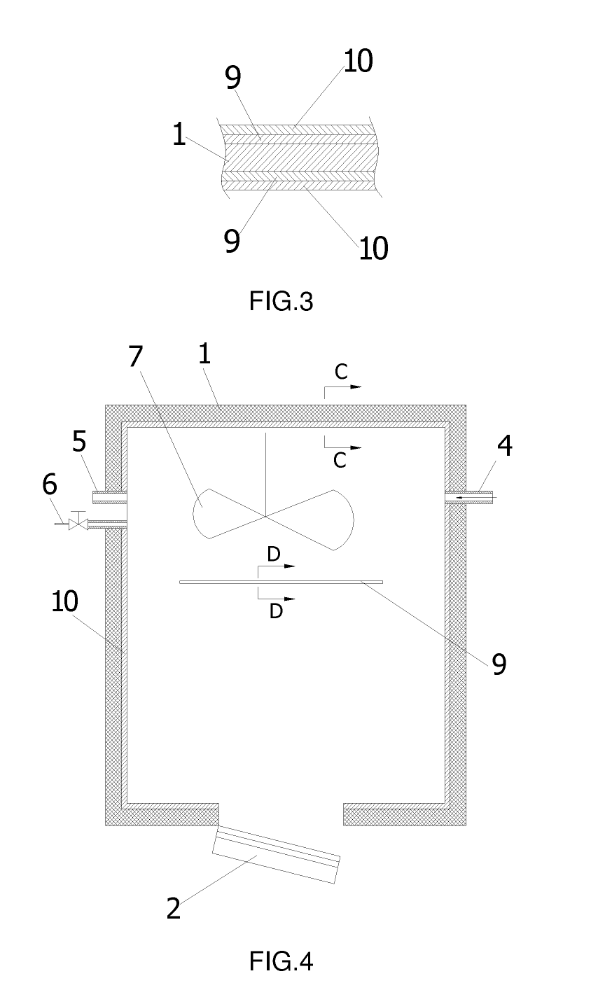

As shown in FIGS. 1-3, a method is provided for treating the surface of a releasing chamber in contact with a test object, the releasing chamber comprising the following components: a chamber 1; a chamber door 2, a suction tube 4, an exhaust tube 5 and a sampling tube 6 connected with the chamber 1; a stirring fan 7 mounted in the chamber 1; and an air duct board 8; the method is used for treating the surface of at least one component of the chamber 1, the chamber door 2, the suction tube 4, the exhaust tube 5, the sampling tube 6, the stirring fan 7 and the air duct board 8 in contact with the test object, comprising the following steps:

(1) with regard to the components made by processing stainless steel or glass, first cleaning each of the components to remove contaminants; if the component is stainless steel, the stainless steel component is oxidized with an acid and then washed with an organic solvent and water, or electrolyzed after oxidation and then washed with an organic solvent and water; if the component is glass, the glass component is corroded by HCL or HF, or the surface thereof is roughened by a physical method; other methods can also be used to wash each of the components to remove contaminants;

(2) first follows production of an intermediate layer 9 by processing the surface of the component washed in step (1), and then production of the deactivated layer 10 by processing the surface of the intermediate layer 9.

Said intermediate layer 9 is a SiO2 layer, or in the form of a three-dimensional mesh or porous skeleton phase, having a thickness from submicron to micron.

Said deactivated layer 10 has a thickness from submicron to micron and a liquid-crystal membrane structure.

If the component is stainless steel, the SiO2 layer of said intermediate layer 9 is obtained by calcining the component washed in step (1) at a temperature above 500° C. with the introduction of monosilane, or by calcining the component washed in step (1) at a temperature above 500° C. after coating, dip-coating or plating it with silicone, or by calcining the component washed in step (1) at a temperature above 500° C. after coating, dip-coating or plating it with polysiloxanes and cyclodextrin derivatives, said polysiloxanes including a polydimethylsiloxane, a phenyl-containing polysiloxane, a cyanogen-containing polysiloxane, a fluorine-containing polysiloxane, a vinyl-containing polysiloxane, a hydrocarbyl-ended polysiloxane, or a polysiloxane with a space group introduced between a molecular chain and a functional group; said intermediate layer 9 or epoxy compound and amine compound containing in a pore-forming agent no carbon atom or heterocycle derived from aromatic compounds undergo a polymerization reaction at 60-200° C. to form a gelatinous substance; then coating or dipping the component washed in step (1), washing away the pore-forming agent with a solvent, and drying after leaving a skeleton phase to form a three-dimensional mesh or porous skeleton phase, said pore-forming agent including methyl cellosolve, ethyl cellosolve, methyl glycol acetate, propylene glycol monomethyl ether acetate and other esters, and polyglycol or polypropylene glycol, said epoxy compound including 2,2,2-tri-(2,3-epoxypropyl)isocyanurate, said amine compound including ethanediamine, diethylene triamine, trithylenetetramine, tetraethylenepentamine, iminobispropylamine/dihexylenetriamine, 1,3,6-triaminomethylhexane, polymethylene diamine, trimethyl hexamethylene diamine, polyether diamine, isophorone diamine, menthane diamine, N-aminoethylpiperazine, 3,9-bis(3-aminopropyl)-2,4,8,10-tetraoxaspiro ring, bis(4-aminocyclohexyl)methane, or aliphatic polyamides made from polyamines and dimer acid; if the component is glass, the intermediate layer 9 is produced by depositing silica, sodium chloride or carbon black onto the surface of the component.

Said deactivated layer 10 is obtained by coating, dip-coating or plating the intermediate layer 9 or the surface of the component with a low-surface-tension organic compound and then baking it at a high temperature above 300° C.; or said deactivated layer 10 is obtained by coating, dip-coating or plating the surface of the component washed in step (1) or the intermediate layer 9 with SiO2 sol and then baking it at a high temperature above 300° C. and finally removing excess materials with a solvent; or said deactivated layer 10 is obtained by coating, dip-coating or plating the surface of the component washed in step (1) or the intermediate layer 9 with polybenzimidazole pyrrolidone (PY), polytetrafluoroethylene, polyfluoroalkyls, orthosilicate or ethyl orthosilicate and then baking it at a high temperature above 300° C.

Said low-surface-tension organic compound includes a silane compound, hydrogen-containing silicone oil or polyglycol. Said silane compound includes chlorotrimethylsilane, hexamethyl disilazane, hydrocarbyl-ended polymethylsiloxane, phenyl-dimethyl polysilane, methyl trioxysilane, dimethyl polysiloxane, diphenyl tetramethyl silazane, polysiloxane or fluorine-containing polysiloxane.

Said low-surface-tension organic compound can also include a fluorinated organic compound.

### Example 2

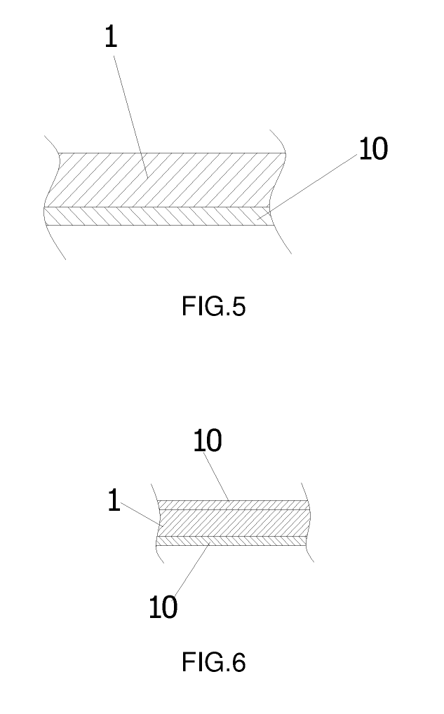

As shown in FIGS. 4-6, a method is provided for treating the surface of a releasing chamber in contact with a test object, the releasing chamber comprising the following components: a chamber 1; a chamber door 2, a suction tube 4, an exhaust tube 5 and a sampling tube 6 connected with the chamber 1; a stirring fan 7 mounted in the chamber 1; and an air duct board 8; the method is used for treating the surface of at least one component of the chamber 1, the chamber door 2, the suction tube 4, the exhaust tube 5, the sampling tube 6, the stirring fan 7 and the air duct board 8 in contact with the test object, comprising the following steps:

(1) with regard to the components made by processing stainless steel or glass, if the component is stainless steel, the stainless steel component is oxidized with an acid and then washed with an organic solvent and water, or electrolyzed after oxidation and then washed with an organic solvent and water; if the component is glass, and then washed with an organic solvent and water; and

(2) then follows direct production of a deactivated layer 10 by processing the surface of the component washed in step (1).

Said deactivated layer 10 has a thickness from submicron to micron and a liquid-crystal membrane structure.

Said deactivated layer 10 is obtained by coating, dip-coating or plating the intermediate layer 9 or the surface of the component with a low-surface-tension organic compound and then baking it at a high temperature above 300° C.; or said deactivated layer 10 is obtained by coating, dip-coating or plating the surface of the component washed in step (1) or the intermediate layer 9 with SiO2 sol and then baking it at a high temperature above 300° C. and finally removing excess materials with a solvent; or said deactivated layer 10 is obtained by coating, dip-coating or plating the surface of the component washed in step (1) or the intermediate layer 9 with polybenzimidazole pyrrolidone (PY), polytetrafluoroethylene, polyfluoroalkyls, orthosilicate or ethyl orthosilicate and then baking it at a high temperature above 300° C.

Said low-surface-tension organic compound includes a silane compound, hydrogen-containing silicone oil or polyglycol. Said silane compound includes chlorotrimethylsilane, hexamethyl disilazane, hydrocarbyl-ended polymethylsiloxane, phenyl-dimethyl polysilane, methyl trioxysilane, dimethyl polysiloxane, diphenyl tetramethyl silazane, polysiloxane or fluorine-containing polysiloxane.

Said low-surface-tension organic compound can also include a fluorinated organic compound.

The above examples are preferred embodiments of the present invention, but the embodiments of the present invention are free from restriction of the above examples, and any other alteration, modification, substitution, combination and simplification made without departing from the spiritual essence and principle of the present invention are equivalent replacements and fall within the scope of protection of the present invention.

What is claimed is:

1. A method for treating a surface of a releasing chamber in contact with a test object, the releasing chamber comprising the following components: a chamber (1); a chamber door (2), a suction tube (4), an exhaust tube (5) and a sampling tube (6) connected with the chamber (1); a stirring fan (7) mounted in the chamber (1); and
an air duct board (8); the method is used for treating the surface of at least one component of the chamber (1), the chamber door (2), the suction tube (4), the exhaust tube (5), the sampling tube (6), the stirring fan (7) and the air duct board (8) in contact with the test object, characterized in that the following steps are comprised:
(1) with regard to the components made by processing stainless steel or glass, first washing each of the components to remove contaminants; and
(2) then follows production of a deactivated layer (10) by processing the surface of the component washed in step (1), or first production of an intermediate layer (9) by processing the surface of the component washed in step (1), and then production of the deactivated layer (10) by processing the surface of the intermediate layer (9).

2. The method for treating the surface of the releasing chamber in contact with the test object according to claim 1, characterized in that, with regard to the components made by processing stainless steel or glass, if the component is stainless steel, the stainless steel component is oxidized with an acid and then washed with an organic solvent and water, or electrolyzed after oxidation and then washed with an organic solvent and water; if the component is glass, the glass component is corroded by HCL or HF, or the surface thereof is roughened by a physical method.

3. The method for treating the surface of the releasing chamber in contact with the test object according to claim 1, characterized in that said intermediate layer (9) is a SiO₂ layer, or in the form of a three-dimensional mesh or porous skeleton phase, having a thickness from submicron to micron.

4. The method for treating the surface of the releasing chamber in contact with the test object according to claim 1, characterized in that said deactivated layer (10) has a thickness from submicron to micron and a liquid-crystal membrane structure.

5. The method for treating the surface of the releasing chamber in contact with the test object according to claim 3, characterized in that if the component is stainless steel, the SiO₂ layer of said intermediate layer (9) is obtained by calcining the component washed in step (1) at a temperature above 500° C. with the introduction of monosilane, or by calcining the component washed in step (1) at a temperature above 500° C. after coating, dip-coating or plating it with silicone, or by calcining the component washed in step (1) at a temperature above 500° C. after coating, dip-coating or plating it with polysiloxanes and cyclodextrin derivatives, said polysiloxanes including a polydimethylsiloxane, a phenyl-containing polysiloxane, a cyanogen-containing polysiloxane, a fluorine-containing polysiloxane, a vinyl-containing polysiloxane, a hydrocarbyl-ended polysiloxane, or a polysiloxane with a space group introduced between a molecular chain and a functional group; said intermediate layer (9) or epoxy compound and amine compound containing in a pore-forming agent no carbon atom or heterocycle derived from aromatic compounds undergo a polymerization reaction at 60-200° C. to form a gelatinous substance; then coating or dipping the component washed in step (1), washing away the pore-forming agent with a solvent, and drying after leaving a skeleton phase to form a three-dimensional mesh or porous skeleton phase, said pore-forming agent including methyl cellosolve, ethyl cellosolve, methyl glycol acetate, propylene glycol monomethyl ether acetate and other esters, and polyglycol or polypropylene glycol, said epoxy compound including 2,2,2-tri-(2,3-epoxypropyl)-isocyanurate, said amine compound including ethanediamine, diethylene triamine, trithylenetetramine, tetraethylenepentamine, iminobispropylamine/dihexylenetriamine, 1,3,6-triaminomethylhexane, polymethylene diamine, trimethyl hexamethylene diamine, polyether diamine, isophorone diamine, menthane diamine, N-aminoethylpiperazine, 3,9-bis(3-aminopropyl)-2,4,8,10-tetraoxaspiro ring, bis(4-aminocyclohexyl)methane, or aliphatic polyamides made from polyamines and dimer acid; if the component is glass, the intermediate layer (9) is produced by depositing silica, sodium chloride or carbon black onto the surface of the component.

6. The method for treating the surface of the releasing chamber in contact with the test object according to claim 1, characterized in that said deactivated layer (10) is obtained by coating, dip-coating or plating the intermediate layer (9) or the surface of the component with a low-surface-tension organic compound and then baking it at a high temperature above 300° C.; or said deactivated layer (10) is obtained by coating, dip-coating or plating the surface of the component washed in step (1) or the intermediate layer (9) with SiO₂ sol and then baking it at a high temperature above 300° C. and finally removing excess materials with a solvent; or said deactivated layer (10) is obtained by coating, dip-coating or plating the surface of the component washed in step (1) or the intermediate layer (9) with polybenzimidazole pyrrolidone (PY), polytetrafluoroethylene, polyfluoroalkyls, orthosilicate or ethyl orthosilicate and then baking it at a high temperature above 300° C.

7. The method for treating the surface of the releasing chamber in contact with the test object according to claim 6, characterized in that said SiO₂ sol is composed of methyltriethoxysilane and tetraethoxysilane hydrolyzate.

8. The method for treating the surface of the releasing chamber in contact with the test object according to claim 6, characterized in that said low-surface-tension organic compound includes a fluorinated organic compound.

9. The method for treating the surface of the releasing chamber in contact with the test object according to claim 6, characterized in that said low-surface-tension organic compound includes a silane compound, hydrogen-containing silicone oil or polyglycol.

10. The method for treating the surface of the releasing chamber in contact with the test object according to claim 9, characterized in that said silane compound includes chlorotrimethylsilane, hexamethyl disilazane, hydrocarbyl-ended polymethylsiloxane, phenyl-dimethyl polysilane, methyl trioxysilane, dimethyl polysiloxane, diphenyl tetramethyl silazane, polysiloxane or fluorine-containing polysiloxane.
